(19) United States
(12) Patent Application Publication
(10) Pub. No.: US 2006/0032647 A1
(43) Pub. Date: Feb. 16, 2006

(54) Quick strike pneumatic pressure regulator

(76) Inventor: Eric M. Petty, Aguanga, CA (US)

Correspondence Address: BUHLER ASSOCIATES;BUHLER, KIRK A., 1101 CALIFORNIA AVE., SUITE 208, CORONA, CA, 92881, US

(21) Appl. No.: 11/253,211

(22) Filed: Oct. 19, 2005

Related U.S. Application Data
(63) Continuation-in-part of application No. 10/866,598, filed on Jun. 14, 2004.

(51) Int. Cl. B27C 3/08

(52) U.S. Cl. 173/169; 173/115

(57) ABSTRACT

A pressure regulator is disclosed that relates to a belt mounted portable pneumatic pressure regulator where a CO2, compressed tank, or similar pressurized canister can be connected to the pressure regulator and a discharge hose can be connected to the regulator. The discharge hose provides a regulated supply of pneumatic air for an air driven power tool, paint gun, or other piece of equipment that operates from a supply of pressurized air. The regulator may include a pressure gauge, adjusting knob, and a pressure relief or burst valve.

### CROSS REFERENCE TO RELATED APPLICATION

This application is a continuation-in-part of U.S. patent application Ser. No. 11/866,598, filed Jun. 14, 2004

### FIELD OF THE INVENTION

The present invention relates generally to a portable pneumatic pressure regulator. More specifically, it relates to a belt or waist mounted pneumatic pressure regulator where a CO₂ or compressed air supply can be connected to the pressure regulator and a hose can be connected to the pressure regulated discharge side of the regulator. The hose provides a regulated supply of pressurized gas or air to an air driven power tool, paint gun, or other piece of equipment that operates from a supply of pressurized gas or air.

### BACKGROUND OF THE INVENTION

Many pressure regulator inventions are used to reduce the pressure from a tank of compressed gas or liquid gas. Most of these inventions are used where the pressurized tank is not transportable, or the tank is installed onto or within the equipment that uses the compressed gas. Other pressure regulators are used for SCUBA, life saving or other apparatus where the regulator is located at the mouth of the user or at the tank. Other regulators may be used to regulate combustible gasses used for heating, welding or welding purposes. One of the major problems with pressure regulators of this type is that the regulator is not portable, or the tank is too large or heavy to be carried with the user.

U.S. Pat. No. 4,186,735 issued to Henneman el al. and U.S. Pat. No. 4,449,524 issued to Gray are regulators attached to respiratory equipment. These patents are intended for use with underwater breathing equipment. The regulators are located at the compressed air tank. While these patents allow for a pressure regulator that is attached to the compressed air tank, the patents are not intended for use with pneumatic tools, nor are they intended for use outside of water. The regulator is also not intended for mounting on the belt of the user.

U.S. Pat. No. 5,515,930 issued to Glasser discloses a pressure regulator that is intended for use with handheld pneumatic power tools. This patent uses a regulator located at a compressed air source. The regulated pressure is fed to a foot controlled flow regulator. After the foot controlled flow regulator, the air then flows into a pneumatic power tool. While this patent allows for a pressure regulator that is attached to the compressed air tank and controls a pneumatic power tool, the regulator is not intended to be mounted on a belt. The patent also uses a foot-operated pedal to control the flow to the pneumatic power tool.

U.S. Pat. No. 4,434,939 issued to Stankowitz, disclose a pressure regulator that is mounted to a pressurized tank that provides regulated air to texture a wall or ceiling. The regulated tank is intended to remain stationary as the user is tethered with a hose to pneumatically powered equipment. While this patent is intended for use with a pneumatic tool, the regulator is not intended to be mounted on the user's belt. The regulator and air tank are not intended to be carried by the user as the user textures a wall or ceiling.

U.S. Pat. No. 4,211,352 issued to Zilka, disclose a pressure regulator located within a nailing machine. The compressed air tank and pressure regulator are enclosed within the nailing machine. The user must hold the weight of the regulator, compressed air tank and the nailing machine. The weight of these components increases the fatigue factor as the operator uses the nailing machine. While this patent allows the pressure regulator to be included with the pressurized tank, the invention is not intended for mounting on the belt of a user.

None of the pressure regulators disclosed is intended to be mounted on the belt of the user, and provide a regulated pressure for use with pneumatic tools or equipment.

### BRIEF SUMMARY OF THE INVENTION

It is an objective of the present invention to provide a portable pressure regulator for use with pneumatic operated equipment. The pressure regulator is designed for mounting on the belt of a user. The regulator includes a coupling mechanism for attaching a tank of compressed air. This configuration of pressure regulator provides a number of advantages to systems that are currently available.

Compressed air is the only power source for a number of pieces of equipment, including nail guns, paint sprayers, texturing equipment, paintball guns and pneumatic automotive tools such as drills, grinders, wrenches, and tire fillers. These pieces of equipment require a regulated supply of compressed gas or air to operate. The supply of compressed air is currently supplied by either a long hose connected to a stationary pressure regulator, or by a supply of compressed air that is integrated within the equipment. The proposed invention provides a superior arrangement for supplying regulated pressurized gas to the equipment by allowing the user to clip the regulator and compressed air to their belt.

With the regulator attached to the user's belt, a canister of compressed air is connected or threaded into the regulator. The regulator swivels on the belt of the user to ensure that the canister remains in an upright orientation. The upright orientation allows the canister to only supply gas and not liquid gas to the regulator. Because the regulator is connected to the user's belt the weight of the regulator and canister is not held in the user's hand. The belt clip may be permanently attached, or could be attached to a removable device that allows the user to disconnect the regulator from the belt to change canisters. A hose is connected or threaded into a second connection on the regulator. The hose provides a regulated supply of pressurized gas from the canister.

The regulator may include an adjustment for the pressure. The pressure adjustment device allows the user to set or adjust the pressure in the hose. The pressure may require adjustment based upon the tool or equipment that is connected to the other end of the hose. The regulator may additionally include a pressure gauge oriented on the regulator housing to allow viewing the pressure in the hose. The pressure gauge allows the operator to visually see and set the pressure in the hose. If the user is torqueing nuts on a car they may require a higher pressure than a person air brushing the paint on a car. An additional component of the regulator may include a burp valve that allows the user to burp or bleed pressure from the hose prior to disconnecting a tool.

Another advantage of this invention is to provide an integrated over-pressure relief valve that can open if the pressure in the regulator or in the hose exceeds a pre-set threshold. This relief valve opens to vent pressure that can be hazardous to the regulator, hose and or connected equipment.

Another advantage of this invention is the pressure in the hose connected to the pneumatic tool is lower. The lower pressure in the hose is safer should a leak or break take place in the hose. This is a safer design as opposed to attaching the regulator to the pneumatic equipment and filling the hose with high-pressure gas.

Still another advantage if this invention is the orientation of the vent hole that vents pressure away from the user to reduce the possibility that the quick release of air will not come in contact with users face while they are removing the bottle from the regulator.

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a perspective view of the invention connected to a tank and air hose.

FIG. 2 is a cross sectional view of the invention showing the internal components.

FIG. 3 is a view of the invention and the belt-mounting device.

### DETAILED DESCRIPTION

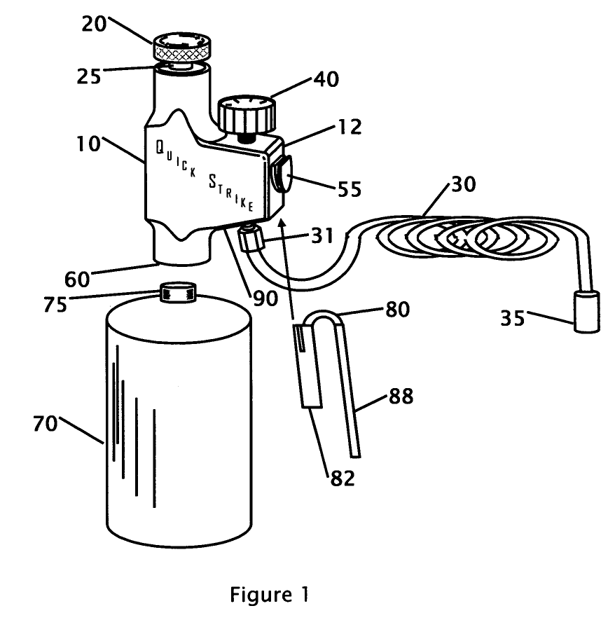

Referring to FIG. 1, that shows a perspective view of the regulator connected to a tank 70, air hose 30 and the regulator 10. In the preferred embodiment the regulator is made from a one piece aluminum body. On one end of the regulator a pressure adjustment knob, item 20, is located. The pressure adjustment knob allows the operator to change or set the pressure on the output side of the pressure regulator. The pressure adjustment knob is knurled around the side of the knob to allow the operator to more easily grip the knob. The under side of the knob threads into the pressure regulator, item 25. As the knob is turned and threads into the regulator body the pressure can be increased or decreased. The pressure being set can be viewed on the pressure gauge, item 40 located on the top of the regulator such that it can be viewed while making adjustment to the pressure using knob 20. The position of the pressure gauge allows the operator to make adjustments without having to tip the regulator to view the pressure gauge. In the preferred embodiment the pressure regulator includes the pressure gauge. The pressure gauge and regulator can be manufactured in different pressure ranges. If the pressure regulator is intended for use with a nailing gun, the output pressure range may be 20 to 150 psi. In the preferred embodiment, the pressure is nominally 100 psi. If the pressure regulator is intended for use with a paint sprayer, the output pressure range may be 2 to 20 psi. In addition to manufacturing the pressure regulator with an adjustable pressure range, the pressure regulator may be manufactured with a fixed pressure set by the manufacturer or requiring a special tool to make the adjustment.

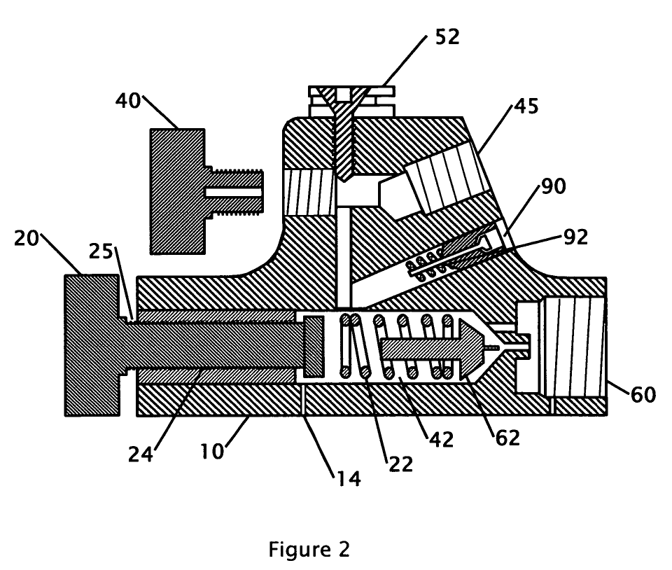

An over-pressure relief discharge valve 90 is located on the underside of the regulator, and will be described in more detail in FIG. 2. The orientation of the over pressure relief valve allows any overpressure to be vented onto the bottle and belt clip to avoid startling the user when a discharge occurs therefore reducing the potential for injury if the pressure was vented against a person. In the preferred embodiment the over-pressure relief valve is set to a pressure of about 135 psi. The location of the over-pressure relief valve further is in a location that is less likely to be blocked. In the preferred embodiment, the pressure regulator is manufactured with an adjustable pressure range, where the adjustment can be performed without a tool. On the side of the regulator opposite the pressure gauge, a connection for a hose 31 is located. The connection can be a threaded connection or a quick release connection. The connection allows attachment of the pneumatic tool or hose to be attached. In FIG. 1, a self-coiling hose, item 30 is shown. The hose allows the operator to use the pneumatic tool without motion restrictions. A self-coiling hose is preferred because the hose retracts and is not as susceptible to knotting or kinking as might occur with a straight hose. The hose may also be a rigid or stiff hose that helps keeps the pneumatic tool in a semi-fixed orientation. The hose connects to the body of the regulator in an angled orientation of approximately 20 degrees using a threaded fitting 31. The angled orientation allows the hose to clear the pressurized canister 70 and still keep the hose in close proximity to the canister. At the end of the hose, a connector, item 35, is attached that allows the pneumatic tool to be connected or disconnected. In the preferred embodiment, the connector is a quick disconnect so the pneumatic tool or tools can be changed quickly. A quick disconnect is any variety of connectors that allows the tool to be disconnected from the hose without tooling and the hose can remain pressurized. The pressure regulator has an extended shoulder 12, which extends from the regulator body.

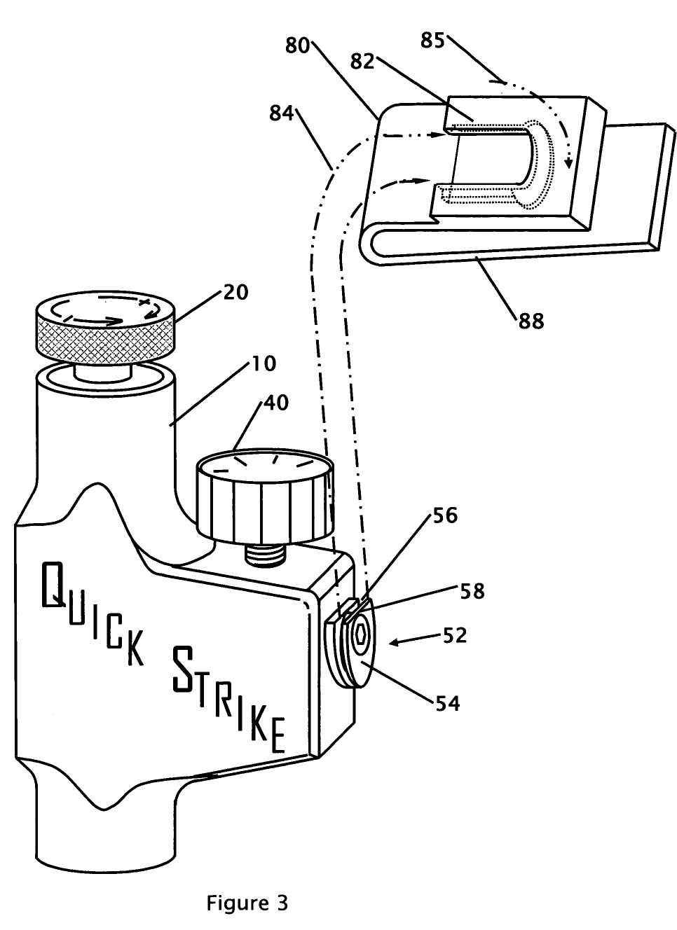

On one side of the extended shoulder, an attachment mechanism is screwed into the extended member. The attachment has a raised “D”, shaped feature connected to the extended shoulder 12. The raised “D” shaped member allows engagement with a belt clip, item 80. The “D” shaped member engages in the belt clip in the area identified by item 82. To engage the “D” shaped member into belt clip, the regulator is rotated 90 degrees so the narrow part of the “D” shape can slide into the belt clip. Once the “D” shaped member is fully engaged into the clip, the regulator is rotated into a vertical orientation and the regulator locks into the belt clip. The belt clip is intended for placement over the belt, pants or pocket of an operator. The belt clip wraps around the belt with item 88. The clip can be a variety of shapes and configurations including a spring clip, or a “U” shaped piece of bent metal. The configuration and material used to make the belt clip requires only that the belt clip can remain on the user's belt as the user moves unrestricted to perform their job. Additional description and the operation of the belt clip and “D” shaped member is described in FIG. 3.

Item 70, is a compressed air, CO2 or non-flammable pressurized canister. The canister can be filled with a variety of gasses from compressed air to liquid gas that is expandable. The canister may also include multiple elements, that when mixed, expand. On at least one side or end of the canister a connection mechanism 75 is located. The coupling or connection mechanism is designed to engage into the end of the pressure regulator at item 60. In the preferred embodiment, the connection mechanism is a threaded coupling that threads into the regulator. As the canister threads into the regulator, the regulator depresses a seal in the canister that allows a flow of pressurized gas to enter the regulator. An optional secondary burst or pressure relief valve can be incorporated onto a side of the body of the regulator to allow the operator to release pressure in the regulator and the hose. This burst valve can be operated by pressing, lifting or turning the valve. This valve is used when the connection to the pneumatic tool does not allow the hose to remain pressurized when the tool is disconnected. The operator sets the pressure to zero, and then activates the relief valve to relieve pressure within the hose. The tool can then be removed without pressure in the hose.

Referring now to FIG. 2 that shows a cross section of an embodiment of the regulator, item 10. This cross sectional view is the preferred embodiment of one particular design of a pressure regulator but various other types of pressure regulators are contemplated that can reduce the pressure from a high-pressure source to a lower pressure. The high-pressure source is connected into one end of the of the pressure regulator in the threaded fitting 60. In the embodiment shown, the high-pressure source is screwed into the regulator. On the opposite side of the regulator pressure adjustment mechanism, item 20 is located. In the embodiment shown, the pressure adjustment device is shown on the opposite side from the high-pressure source connection, but the location of the pressure adjustment device can be located on any side of the regulator the allows adjustment of the regulated pressure. On the under side of the pressure adjustment device, is a threaded rod, item 25, that threads into the body of the regulator 24 to allow adjustment of the output pressure. As the pressure adjustment device is threaded in and out of the body of the regulator, the pressure adjustment device compresses a spring 22. The spring applies pressure to the sealing rod 62 located on the end where the high-pressure supply is attached 60. The sealing rod biases against the regulator housing to control the pressure differential between the pressurized air and the pressure in the regulator chamber 42. One or more dowel pins and loctite is used to lock the components into the body of the regulator and prevent people from tampering with the internal components. Vent hole 14 is activated when the adjustment knob 20 is backed out, allowing the piston to move and lets pressure within the regulator to escape through the vent hole.

The pressure within the regulator is available at the coupling connection of the hose at item 45. The vent is held closed by pressure in the regulator housing and by a spring, item 92. The over pressure vent is opened when the air pressure within the regulator exceeds a pre-defined pressure, and the pressure is vented out of port 90. In the preferred embodiment the over pressure vent is set to a pressure of about 135 psi to allow the regulator to vent at a pressure that would not cause harm to the hose, or the regulator itself. A “D” belt adapter is 52 is attached to the body of the regulator to allow the regulator to be removed from a belt attachment device. A pressure gauge 40 is threaded into the body of the regulator and is located on the top of the regulator positioned such that it can be viewed by a user as they are adjusting the pressure using knob 20. It is contemplated that the regulator may further include a burp or venting port that can be manually opened to vent pressure in the regulator housing and hose prior to disconnecting to hose to reduce the risk of injury from letting the hose vent into the air.

Referring now to FIG. 3 that shows an embodiment of the regulator and the belt-coupling or mounting device. The orientation of the regulator body 10 in this figure shows how the regulator will be oriented for use by the user, with the adjustment knob 20 and the pressure display gauge 40 it the top position. In FIG. 3, the attachment mechanism is shown rotated to provide better clarity of the features and to show the orientation required to slide the regulator onto the belt clip. One part of the belt attachment device 52 is attached to the regulator body by threading a screw through the attachment device and into the regulator. The attachment device consists of a raised area 58. The top of the raised area is a generally flat undercut raised semi-circular shaped feature 56, with a flat 54, giving the part an appearance of a “D” shape. The belt clip, item 80, is shown located above and to the right of the attachment mechanism. Arrows 84 shows the motion of moving the attachment mechanism into the belt clip 82 and arrow 85 shows rotation of the attachment device in the belt clip to lock the attachment device into the belt clip. When the “D” shaped member is seated and rotated into the belt clip, the “D” shape maintains the attachment device in the belt clip while the pressure regulator is in a vertical or near vertical orientation. The belt clip is a bent over section 88 to allow the belt clip to remain retained to a belt, waistband or pocket.

Thus, specific embodiments and applications of a belt mountable pressure regulator have been disclosed. It should be apparent, however, to those skilled in the art that many more modifications besides those described are possible without departing from the inventive concepts herein. The inventive subject matter, therefore, is not to be restricted except in the spirit of the appended claims.

What is claimed is:

1. A portable pneumatic regulation system comprising:
a pneumatic pressure regulator;
a first coupling on the pneumatic pressure regulator for a compressed pneumatic tank;
a second coupling on the pneumatic pressure regulator wherein regulated pressure is available, and;
a third coupling mechanism on the pneumatic pressure regulator for attaching the pneumatic pressure regulator to the belt of a user.

2. The portable pneumatic regulation system from claim 1 that further includes a pressure gauge.

3. The portable pneumatic regulation system from claim 1 wherein the pressure regulator also includes a pressure adjustment mechanism.

4. The portable pneumatic regulation system from claim 1 wherein the pressure regulator also includes a burst valve.

5. The portable pneumatic regulation system from claim 1 wherein the couplings are selected from a group consisting of threaded or quick coupling.

6. The portable pneumatic regulation system from claim 1 wherein the third coupling mechanism is selected from a group consisting of a clip, cam, D shape, U shape, spring clip.

7. The portable pneumatic regulation system from claim 1 that further includes an over-pressure relief valve.

8. A portable pneumatic regulation system comprising:
a portable non-combustible non-respiratory pressure regulator with,
a first coupling on the pressure regulator for a compressed tank,
a second coupling on the pressure regulator where regulated pressure is available, and;
an attachment mechanism for attaching the pressure regulator to the belt of a user.

9. The portable pneumatic regulation system from claim 8 wherein the pressure regulator also includes a pressure gauge.

10. The portable pneumatic regulation system from claim 8 wherein the pressure regulator also includes a burst valve.

11. The portable pneumatic regulation system from claim 8 wherein the coupling is selected from a group consisting of threaded or quick coupling.

12. The portable pneumatic regulation system from claim 8, wherein the decoupling mechanism is selected from a group consisting of a clip, cam, D shape, U shape, or spring clip.

13. The portable pneumatic regulation system from claim 8 that further includes an over-pressure relief valve.

14. A pressure regulator comprising:
a pressure regulator for pneumatic tools with a first coupling on the pressure regulator for a compressed tank,
a second coupling on the pressure regulator where regulated pressure is available, and
a coupling mechanism on the pneumatic pressure regulator for attaching the pressure regulator to the belt of a user.

15. The pressure regulator from claim 14 wherein the pressure regulator further includes a pressure gauge.

16. The pressure regulator from claim 14 wherein the pressure regulator further includes a burst valve.

17. The pressure regulator from claim 14 wherein the coupling is selected from a group consisting of threaded or quick coupling.

18. The pressure regulator from claim 14 wherein the decoupling mechanism is selected from a group consisting of a clip, cam, D shape, U shape, or spring clip.

19. The pressure regulator from claim 14 that further includes an over-pressure relief valve.

20. The pressure regulator from claim 14 wherein the pressure regulator further includes a pressure adjustment mechanism.
